(19) United States
(12) Patent Application Publication
(10) Pub. No.: US 2026/0371468 A1
(43) Pub. Date: Nov. 19, 2026

(54) DISPLAY SYSTEM, LIGHT SOURCE AND METHOD FOR OPERATING THE DISPLAY SYSTEM

(71) Applicant: Dynavisual AG, Zug (CH)

(72) Inventors: Nicola RAMAGNANO, Rapperswil (CH); Heinz Christian MATHIS, Uerikon (CH)

(21) Appl. No.: 19/147,224

(22) PCT Filed: Jan. 18, 2023
(86) PCT No.: PCT/EP2023/051140

§ 371 Date: Jul. 10, 2025

(51) Int. Cl. H05B 47/195; H05B 45/14; H05B 45/24; H05B 47/11

(52) U.S. Cl. CPC H05B 47/195; H05B 45/14; H05B 45/24; H05B 47/11

(57) ABSTRACT

Display system, comprising a plurality of movable light sources (2), each having a lamp (3), a control unit (4), a data transmission unit (5) and a power supply unit (6), wherein for each light source (2) the lamp (3), the control unit (4), the data transmission unit (5) and the power supply unit (6) are operatively connected to one another, a central processing unit (7), at least one data transmission unit (8), which is operatively connected at least temporarily on the one hand to the central processing unit (7) and on the other hand to the data transmission unit (5) of the light sources (2). The display system according to the invention is characterized in that the light sources (2) comprise at least one infrared transmitter (9, 9′) operatively connected to the control unit (4) for generating infrared signals, in that each light source (2) is assigned a unique identification code which can be transmitted with the infrared signal, in that at least one image capture unit (10, 11) is provided for capturing the infrared signals emitted by the infrared transmitters (9, 9′), in that the at least one image capture unit (10, 11) is operatively connected to the central processing unit (7), in which the positions of the individual light sources (2) can be determined, and in that the central processing unit (7) has a data memory with image data which is processed at least partially and as a function of the position of the light sources (2) and is transmitted to them for adjusting the brightness and/or color of the corresponding lamp (3).

### TECHNICAL FIELD

The present invention relates to a display system according to the preamble of claim 1, a light source for use in the display system and a method for operating the display system.

### STATE OF THE ART

It is well known that at large events, such as concerts or sporting events, mobile devices belonging to event attendees are used to create a giant screen. The mobile devices carried by the event attendees are used as pixels or image elements of the giant screen and are controlled accordingly via a central server. This allows spectator areas, such as individual stands or an entire stadium, to be included in the game at sporting events. The same applies to artistic performances such as concerts or musicals.

To achieve high image quality on the resulting giant screen, it is essential that the positions of the individual image elements are precisely known. The simplest solution proposed has therefore been to install a fixed installation with a remotely controllable lamp at each seat. A central control unit with a central server is used to adjust the brightness and/or color of the lamp at a given time so that the overall image on the resulting giant screen corresponds to the desired image.

However, this well-known solution has the major disadvantage of requiring extremely complex installation work. In addition to the fixed installations for the lamps, which can also obstruct the field of vision of event attendees, the wiring for the lamps is also a significant effort.

For this reason, solutions for locating event visitors' mobile devices have already been proposed.

A known teaching for determining the respective position of mobile telephone devices is disclosed in WO 2014/096861 A1. The transmitting and receiving units typically present in the mobile devices are used to determine the position of the devices. This can be a protocol based on the Bluetooth standard, or a protocol based on the WLAN (Wireless LAN) standard.

However, many event attendees refuse access to their mobile devices for data protection reasons, which makes it difficult or even impossible for the giant screen to function properly.

Furthermore, EP 3 307 025 A1 describes a variety of lamps whose positions are determined using GPS (Global Positioning System). Alternatively, the position can also be determined by emitting high-frequency reference signals at defined locations in a stage, and a receiving unit at the light source determines the position based on the different signal propagation times of the reference signals.

Furthermore, it has already been proposed to provide event attendees with mobile lamps. For example, EP 3 307 025 A1 discloses distributing hats to event attendees that are equipped with integrated lamps and the necessary electronics for communication with a central server. GPS (Global Positioning System) has been proposed for positioning. Accordingly, each unit carrying the lamp must be equipped with a GPS receiver and the associated transceiver unit, which is operatively connected to the central server.

Using this known method, a giant screen can be realized if the lamps—i.e., the individual pixels—are not stationary but move. Due to the known positions of the lambs, the central Server can adapt the intensity and/or color of the lamp to the respective location, so that the overall impression of the image displayed on the giant screen remains within the desired projection range. However, this known system is also very complex to implement and therefore correspondingly costly. Furthermore, the position determined via GPS is relatively inaccurate for this application, which can lead to distortions in the displayed image. The use of GPS signals is often not possible, especially indoors, as they are shielded by the building envelope.

### DESCRIPTION OF THE INVENTION

An object of the present invention is therefore to be able to produce a giant screen with mobile lamp units which is overall simpler and thus more cost-effective and can be implemented indoors.

This object is achieved by the features specified in the characterizing part of claim 1. Further embodiments are defined by the features specified in the dependent claims.

A display system according to the invention is specified, comprising:
a plurality of movable light sources, each having a lamp, a control unit, a data transmission unit, and a power supply unit, wherein for each light source, the lamp, the control unit, the data transmission unit, and the power supply unit are operatively connected to one another,
a central processing unit,
at least one data transmission unit, which is operatively connected, at least temporarily, on the one hand, to the central processing unit and on the other hand, to the data transmission unit of the light sources.

The display system according to the invention is characterized in that:
the light sources comprise at least one infrared transmitter operatively connected to the control unit for generating infrared signals;
each light source is assigned a unique identification code that can be transmitted with the infrared signal;
at least one image capture unit is provided for capturing the infrared signals emitted by the infrared transmitters;
the at least one image capture unit is operatively connected to the central processing unit, in which the positions of the individual light sources can be determined; and
the central processing unit has a data memory with image data that is processed at least partially and depending on the position of the light sources and transmitted to them for adjusting the brightness and/or color of the corresponding lamp.

The display system according to the invention proposes a cost-effective infrared transmitter in each light source, which emits a unique identification code and can be detected by an image capture unit in order to reliably locate all light sources within a given area.

An embodiment of the display system according to the invention consists in that the infrared signals have a wavelength in the range of 700 nm to 1400 nm.

This wavelength range corresponds to the near-infrared spectrum, which lies just below the visible spectrum. It has the advantage of being invisible to the human eye and to cameras with an optical filter that blocks infrared signals. Another advantage of near-infrared is that this spectral range is very rarely used, thus minimizing interference from other communication devices.

Further embodiments of the display system according to the invention consist in the infrared signals having a wavelength of 940 nm.

Further embodiments of the display system according to the invention consist in that a bandpass filter is arranged in front of the image capture unit, wherein the bandpass filter primarily lets infrared signals with wavelengths in the range from 700 nm to 1400 nm pass through.

This advantageously attenuates ambient light outside the infrared range before it reaches the image capture unit's sensor. This allows the use of high sensor amplification, which allows weak infrared signals to be detected, since the image capture unit's sensor cannot be saturated by ambient light—i.e., light in the visible range. Preferably, the passband of the bandpass filter is reduced to such an extent that essentially only signals with the wavelength of the emitted infrared signal are allowed to pass, i.e., wavelengths in the range of 940 nm+/−20 nm.

Further embodiments of the display system according to the invention consist in that the light source is arranged on a cap. Further embodiments of the display system according to the invention consist in the fact that the lamp is of the LED (light emitting diode) type.

Further embodiments of the display system according to the invention consist in that at least two infrared transmitters are provided per light source, wherein the infrared transmitters are arranged such that they are visible from different directions.

This ensures that the light sources can be located even if the light source carrier is moving significantly, as detection occurs from different directions.

Further embodiments of the display system according to the invention consist in providing reference points with previously known positions in which at least one infrared transmitter is arranged.

With the reference points arranged at precisely defined positions, the display system can be easily calibrated, ensuring the precise location of the light sources at all times.

Furthermore, a light source for use in a display system is specified, wherein the light source comprises a lamp, a control unit, a data transmission unit and a power supply unit, and wherein the lamp, the control unit, the data transmission unit and the power supply unit are operatively connected to one another.

The light source according to the invention is characterized in that:
the control unit is operatively connected to at least one infrared transmitter for generating infrared signals,
a unique identification code can be transmitted to the at least one infrared transmitter using the infrared signal in order to determine the position of the infrared transmitter after detection by an image capture unit,
the data transmission unit can receive a brightness value and/or a color value for adjusting the brightness value and/or the color value of the lamp.

An embodiment of the light source according to the invention consists in that the infrared signals have a wavelength in the range of 700 nm to 1400 nm.

Further embodiments of the light source according to the invention consist in that the infrared signals have a wavelength of 940 nm.

Finally, a method for operating a display system is specified, the method comprising the steps of:
emitting an infrared signal comprising a modulated identification code that is unique for a respective light source,
capturing the infrared signal with an image capture unit,
determining a current position of the light source,
determining a brightness value and/or a color value of a light source based on its position and stored image data,
transmitting the brightness values and/or color values to the respective light sources,
setting the brightness values and/or color values in the light sources.

A further embodiment of the method according to the invention consists in that the infrared signals have a wavelength in the range of 700 nm to 1400 nm.

Further embodiments of the method according to the invention consist in that the infrared signals have a wavelength of 940 nm.

Further embodiments of the method according to the invention comprise filtering signals with a bandpass filter before detection with the image processing unit, wherein the bandpass filter primarily lets infrared signals with wavelengths in the range from 700 nm to 1400 nm pass through.

The aforementioned embodiments of the display device, light source, or method can be combined in any way. Only those combinations are excluded that would obviously lead to a contradiction.

### SHORT DESCRIPTION OF THE FIGURES

Embodiments of the present invention are explained in more detail below with reference to the accompanying figures. These figures are for illustrative purposes only and are not to be construed as limiting. It shows:

FIG. 1 a display system according to the present invention with multiple movable light sources,

FIG. 2 a block diagram of a light source according to the invention, and

FIG. 3 a flowchart with method steps for determining the position of a light source.

### DETAILED DESCRIPTION OF THE INVENTION

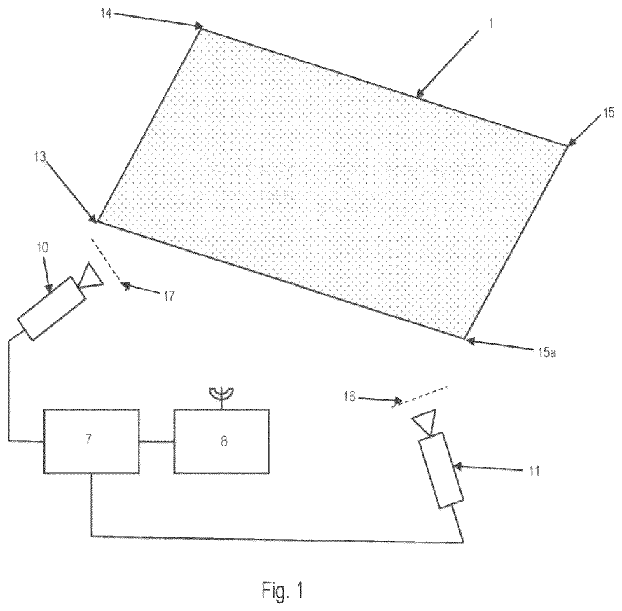

FIG. 1 shows a schematic representation of a display system according to the invention, consisting of a projection surface 1 with a plurality of movable light sources as well as a central processing unit 7, a data transmission unit 8 and two image capture units 10 and 11.

The light sources located within projection surface 1 form a giant screen, with the individual light sources being image elements or pixels of the giant screen. The projection surface 1 can be part of a stand or other spectator area of an event venue, such as a sports stadium, theater, or concert hall. It is intended that each event attendee wears a light source, although this is not mandatory.

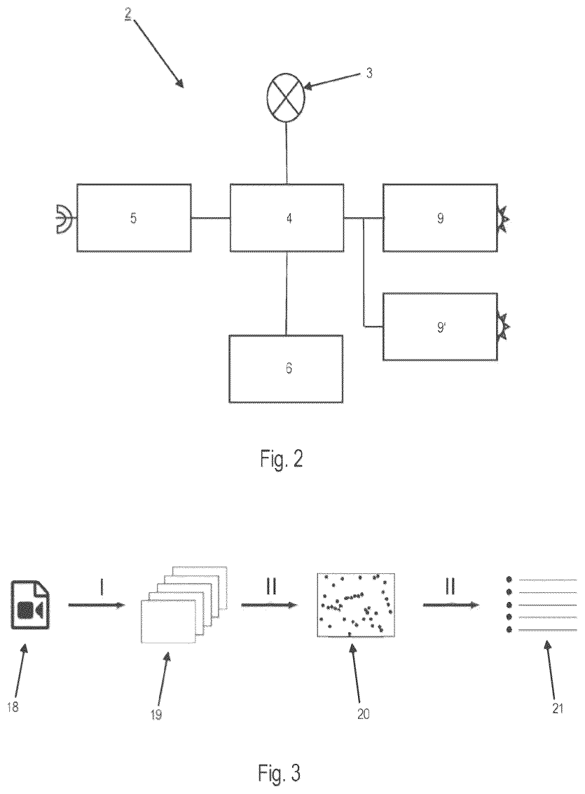

The structure of the light sources will be explained in detail with reference to FIG. 2.

For correct image generation on the projection surface 1, the positions of the pixels, i.e., the light sources, on the projection surface 1 must be known. For this purpose, in addition to an appropriate design of the light sources, the operatively connected central processing unit 7, the data transmission unit 8, and the two image capture units 10 and 11 are provided. It should be noted that it is not necessary to have two image capture units 10, 11. Embodiments of the present invention with a single image capture unit or with several, in particular with more than two, image capture units are also conceivable. The use of multiple image capture units has the advantage that the positions of the light sources can be determined more robustly and reliably.

FIG. 2 shows a block diagram of a light source 2 according to the invention, which consists of a lamp 3, a control unit 4, a data transmission unit 5, a power supply unit 6, and at least one infrared transmitter 9, 9′. These components of the light source 2 are operatively connected to one another and, as far as possible, manufactured with high levels of integration in order to obtain a cost-effective light source 2 and to keep the overall weight of the light source 2 as low as possible.

To keep energy consumption as low as possible and to ensure the operation of the light source 2 for as long as possible, the lamp 3 is implemented, for example, using LEDs (light-emitting diodes) or an LED matrix. The same applies to the infrared transmitters 9, 9′, which are implemented with IR diodes.

The data transmission unit 5 can be designed as a pure data reception unit or as a bidirectional data transmission unit and serves as a communication unit with the data transmission unit 8 (FIG. 1). The information for controlling the lamp 3 is determined or processed, for example, in the central processing unit 7 and transmitted by the data transmission unit 8 via a wireless connection to the data transmission unit 5. For this purpose, known transmission protocols such as those used in Bluetooth or WLAN (Wireless Local Area Networks) can be used.

The infrared transmitters 9 and 9′ are essential components used to determine the position of the light source 2. The infrared transmitters 9, 9′ emit an infrared signal invisible to the human eye, containing an identification code unique to the respective light source 2. The infrared transmitter 9, 9′ emits, for example, infrared signals in the so-called near infrared range, with wavelengths in the range from 700 nm to 1400 nm. In a particular embodiment of the present invention, the wavelength is essentially 940 nm.

The infrared signals emitted by the infrared transmitters 9, 9′ are captured by the image capture units 10, 11 and processed in the central processing unit 7 to identify the respective light source 2. Accordingly, the image capture units 10, 11 are sensitive to the respective infrared spectrum of the infrared transmitters, i.e., the corresponding infrared signals from the infrared transmitters 9, 9′ can be captured and detected in the image capture units 10, 11.

To further improve the sensitivity of the image capture units 10, 11, in a further embodiment of the present invention, an optical bandpass filter 16, 17 is arranged in front of the respective image capture unit 10, 11—i.e., in front of their sensors. This significantly attenuates signals that lie outside the near infrared range used by the infrared transmitters 9, 9′—such as ambient light in the visible range—so that these visible signal components cannot saturate the sensor of the respective image capture unit 10, 11. This allows the weaker infrared signals to be amplified more and thus easier to evaluate. Sensitivity is also improved by increasing the useful signal/interference signal ratio (also called the signal-to-interference ratio) through the use of the bandpass filter.

To distinguish the individual light sources 2, each light source 2 is assigned a unique identification code. The identification code is embedded in a signal sequence consisting of a synchronization sequence, an identification code, and a checksum. This allows the image capture unit 10, 11 to reliably determine the identification codes after receiving them from the infrared transmitter 9, 9′, which will become clear in the following explanations.

Each message sequence begins with the synchronization sequence, which is identical for each light unit 2. The goal and purpose of the synchronization sequence is to define the beginning of the message sequence so that the start of the message sequence can be clearly detected. The synchronization sequence is followed by the identification code, which can also be detected after the synchronization sequence has been detected. Finally, the checksum (e.g., CRC-16—cyclic redundancy check) is provided, which allows the detection of a transmission error.

The reporting sequence is used to modulate the intensity of the IR diodes of the infrared transmitter 9, 9′. For example, on-off keying (OOK) is used as a modulation method, which represents digital data as the presence or absence of the carrier signal. The synchronization sequence is chosen to exhibit excellent autocorrelation properties. This makes it easier for the image capture unit 10, 11 to detect the synchronization sequence within the received signal and determine the exact position, since the highest correlation value is only found at zero time shift. The length of the synchronization sequence is a compromise between autocorrelation performance and message duration. On the one hand, the more chips used for the synchronization sequence, the better the autocorrelation property. On the other hand, a longer synchronization sequence increases the message duration. Furthermore, the speed with which the position of a light source 2 can be calculated decreases. For example, the synchronization sequence comprises 48 chips and is generated using a heuristic search-based algorithm, as described, for example, in the paper by authors M. Dimitrov, T. Baitcheva, and N. Nikolov entitled “Efficient Generation of Low Autocorrelation Binary Sequences” (IEEE Signal Processing Letters, vol. 27, pp. 341-345, 2020).

Furthermore, the number of on and off bits in the synchronization sequence was intentionally chosen to be equal to avoid correlation drift caused by background brightness. The same property is achieved for the remaining bits (i.e., the identification code and the checksum) using a technique called BOC (Binary Offset Carrier) modulation. In BOC modulation, the data bits are multiplied by a binary carrier signal, which can have two, three, or more half-periods per bit. All carriers with an even number of half-periods have the same number of on and off parts (also called chips). For example, “BOC Sine-2” modulation (also called Manchester code) with two half-periods per bit is used.

For example, the identification code is specified as 24 bits, allowing a total of 16 million unique identification codes. Together with the 16 bits of the CRC-16 checksum, this results in a total of 24+16=40 bits, or 80 chips when using BOC Sine-2 modulation. Thus, the entire message consists of 48+80=128 chips.

In FIG. 1, the image capture units 10 and 11 are connected to the central processing unit 7 via a wired connection. An alternative embodiment of the present invention provides that the image capture units 10 and 11 are connected to the central processing unit 7 via a wireless connection.

With the image capture units 10 and 11, film sequences are recorded, for example, with a single image size of 1640×1232 pixels and an image sequence of 30 images per second.

The image rate of the image capture units 10 and 11 also determines the maximum permissible chip rate that the infrared transmitter 9, 9′ can use to transmit its message. If all infrared transmitters 9, 9′ are theoretically perfectly synchronized with the image capture unit 10, 11, a single image per transmitted chip would theoretically suffice.

If the infrared transmitters 9, 9′ are not synchronized with the image capture unit 10, 11, the exposure time of an image with two adjacent chips may overlap, which may lead to an incorrect amplitude if the two chips are unequal.

It has therefore been shown that the use of three individual images per chip can be tolerated, albeit with a slight loss of amplitude. With an image rate of 30 images per second, three images per chip, and a total of 128 chips for a message, the total duration of a message is 12.8 seconds.

The video file 18 recorded with the image capture unit 10, 11 described above is processed on the central processing unit 7 to obtain a list of all valid messages from the infrared transmitters 9, 9′ present in the video file 18. This occurs in Several steps I to III, which are explained below with reference to FIG. 3.

The first step I consists of extracting all images from the video file 18 and saving them as a multidimensional series 19 (an “array of frames” or “image sequence” or “image series”). This facilitates the calculations applied to all individual images. To reduce storage requirements, each individual image can be reduced in size, for example, through reduction (so-called “pixel binning”).

In a simplified embodiment of the present invention, the video sequences captured by the image capture units 10, 11 are processed directly into the multidimensional series 19, i.e. the video sequences are not stored in the aforementioned video files.

The second step (II) consists of searching for a synchronization sequence at each pixel position. This is done by cross-correlating the synchronization sequence with the values of a pixel across all frames. Here, calculating the cross-correlation using the Fast Fourier Transform (FFT) is proposed, as this significantly speeds up the calculations. The highest absolute correlation value of each pixel is then compared with a threshold value corresponding to the correlation value of a pixel with the minimum permissible signal amplitude. This way, only the pixels with a higher probability are considered.

This approach assumes that the light source 2 remains at approximately the same location (i.e., equally illuminated pixels) throughout the duration of a reporting sequence. The result of this processing step is a list of pixels that can be considered as possible candidates with a valid reporting sequence.

In the third step III, the report sequences are extracted and decoded to verify the checksum for all report sequences. The result is a list containing the pixel coordinates, the report sequences, and the estimated signal amplitude for each pixel.

Once the pixel coordinates of the detected infrared transmitters 9, 9′ are known, they can be transformed into position coordinates within the projection surface 1. The underlying geometric problem can often be simplified within the considered projection surface 1, since the possible positions of the light sources 2 are limited to positions in a stadium where spectators can be present. For example, spectators can move freely within a stand, meaning that all or at least part of the stand is considered a geometric plane. Thus, the transformation problem consists of relating a point on the image plane (within the image capture unit 10, 11) to a point on the plane of the projection surface 1. In image processing, the relationship between any two planes in space is called homography, which is explained, for example, in «Basic Concepts of the Homography explained with Code» (OpenCV, downloadable at: https://docs.opencv.org/4.x/d9/dab/tutorial_homography.html).

The position (x, y) of one plane can be converted into the position (x′, y′) of the other plane using the homography matrix M.

The homography matrix H can be calculated based on at least four known reference points 13, 14, 15, 15a between the two planes. In practice, for example, the four corners of a projection surface 1 can be considered reference points 13-15, 15a and temporarily equipped with infrared transmitters 9, 9′, for example. The known positions of the reference points 13-15, 15a and the pixel coordinates from the image can then be used to calculate the matrix H. As long as the respective image capture unit 10, 11 is aligned in the same way, the homography matrix remains valid and the reference points 13-15, 15a are no longer needed.

The display system according to the invention has been shown to be extremely robust and delivers precise results regarding the position of the movable light sources 2. Position inaccuracies of an average of 4 cm were determined over larger distances, which is extremely low considering an average distance between two light sources 2 of 60 cm. Accordingly, giant screens can be easily implemented at large events using the display system according to the invention. It has proven particularly advantageous if the light source 2 and all its components are integrated into a cap, in particular a peaked cap, and thus provided to the audience to wear during the event.

### REFERENCE SIGNS

1 Projection surface
2 Light source
3 Lamp
4 Control unit
5 Data transmission unit
6 Power supply unit
7 Central processing unit
8 Data transmission unit
9, 9′ Infrared transmitter
10, 11 Image capture unit
12 Bandpass filter
13-15, 15a Reference points
16, 17 Bandpass filter
18 Video file or video source
19 Frame series (array of frames)
20 Pixels with high correlation values
21 Pixel list with valid messages

1. A display system comprising:
a plurality of movable light sources (2), each having a lamp (3), a control unit (4), a data transmission unit (5), and a power supply unit (6), wherein for each light source (2), the lamp (2), the control unit (4), the data transmission unit (5), and the power supply unit (6) are operatively connected to one another;
a central processing unit (7);
at least one data transmission unit (8), which is operatively connected, at least temporarily, on the one hand to the central processing unit (7) and on the other hand to the data transmission unit (5) of the light sources (2);
characterized in:
that the light sources (2) comprise at least one infrared transmitter (9, 9′) operatively connected to the control unit (4) for generating infrared signals;
that each light source (2) is assigned a unique identification code that can be transmitted with the infrared signal;
that at least one image capture unit (10, 11) is provided for capturing the infrared signals emitted by the infrared transmitters (9, 9′),
that the at least one image capture unit (10, 11) is operatively connected to the central processing unit (7), in which the positions of the individual light sources (2) can be determined, and
that the central processing unit (7) has a data memory containing image data that is processed at least partially and depending on the position of the light sources (2) and transmitted to them for adjusting the brightness and/or color of the corresponding lamp (3).

2. Display system according to claim 1, characterized in that the infrared signals have a wavelength in the range of 700 nm to 1400 nm.

3. Display system according to claim 2, characterized in that the infrared signals have a wavelength of 940 nm.

4. Display system according to claim 1, characterized in that a bandpass filter (16; 17) is arranged in front of the image capture unit (10; 11), wherein the bandpass filter (16; 17) primarily lets infrared signals with wavelengths in the range from 700 nm to 1400 nm pass through.

5. Display system according to claim 1, characterized in that the light source (2) is arranged on a cap.

6. Display system according to claim 1, characterized in that the lamp is of the LED (light emitting diode) type.

7. Display system according to claim 1, characterized in that at least two infrared transmitters (9, 9′) are provided per light source (2), wherein the infrared transmitters (9, 9′) are arranged such that they are visible from different directions.

8. Display system according to one of claim 1, characterized in that reference points (13, 14, 15, 15a) with previously known positions are provided, in which at least one infrared transmitter (9, 9′) is arranged.

9. A light source (2) for use in a display system according to claim 1, wherein the light source (2) comprises a lamp (3), a control unit (4), a data transmission unit (5), and a power supply unit (6), and wherein the lamp (3), the control unit (4), the data transmission unit (5), and the power supply unit (6) are operatively connected to one another, characterized in
that the control unit (4) is operatively connected to at least one infrared transmitter (9, 9′) for generating infrared signals,
that a unique identification code can be transmitted to the at least one infrared transmitter (9, 9′) using the infrared signal in order to be able to determine the position of the infrared transmitter (9, 9′) after detection by an image capture unit (10, 11),
that a brightness value and/or a color value can be received by the data transmission unit

(5) for adjusting the brightness value and/or the color value of the lamp (3).

10. Light source (2) according to claim 9, characterized in that the infrared signals have a wavelength in the range of 700 nm to 1400 nm.

11. Light source (2) according to claim 10, characterized in that the infrared signals have a wavelength of 940 nm.

12. A method for operating a display system according to claim 1, wherein the method comprises the steps of:
emitting an infrared signal comprising a modulated identification code that is unique for a respective light source (2),
detecting the infrared signal with an image capture unit (10, 11),
determining a current position of the light source (2),
determining a brightness value and/or a color value of a light source (2) based on its position and stored image data,
transmitting the brightness values and/or the color values to the respective light sources (2),
setting the brightness values and/or the color values in the light sources (2).

13. The method according to claim 12, characterized in that the infrared signals have a wavelength in the range of 700 nm to 1400 nm.

14. The method according to claim 13, characterized in that the infrared signals have a wavelength of 940 nm.

15. Method according to claim 9, characterized by filtering signals with a bandpass filter (16; 17) before detection with the image processing unit (10; 11), wherein the bandpass filter (16; 17) primarily lets infrared signals with wavelengths in the range from 700 nm to 1400 nm pass through.
